(19) United States
(12) Patent Application Publication
(10) Pub. No.: US 2003/0189317 A1
(43) Pub. Date: Oct. 9, 2003

(54) Wheel chair assembly

(76) Inventors: Zen-Jye Chen, Taichung (TW); Hsiang-Suen Lin, Taichung (TW); Wen-Huei Chung, Taichung (TW); Shsu-Tung Chu, Taichung (TW); Chi-Ming Shih, Taichung (TW); Yen-Sheng Yang, Miaoli (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/205,441

(22) Filed: Jul. 26, 2002

(30) Foreign Application Priority Data
Apr. 3, 2002 (TW) 091204454

(51) Int. Cl. B62B 1/00

(52) U.S. Cl. 280/650

(57) ABSTRACT

A wheel chair assembly includes two identical side assemblies each of which has a front part and a rear part and a top link and a low link are respectively inserted in the horizontal fittings on the front part and the rear part. A pivotable device is pivotally connected between the top links and the low links of the two side assemblies. A hanger bracket and a caster are respectively connected to each of the front part. The rear parts each have a plurality of holes so that the shaft of the rear wheel is inserted in one of the holes.

### FIELD OF THE INVENTION

The present invention relates to a wheel chair assembly which includes modular parts that are easily to be assembled and allow the users to adjust the size of the wheel chair so as to meet needs.

### BACKGROUND OF THE INVENTION

A conventional wheel chair generally includes a plurality of metal tubes which are welded or soldered to be a specific shape of assembly and the assemblies are connected with each other to form a wheel chair. Generally, the conventional wheel chair is assembled by two side assemblies which are the same and a pivotable device is used to connect the two side assemblies. The shape of each of the side assemblies is fixed and cannot be adjusted so that the conventional wheel chairs can only be folded by pivoting the pivotable device to push the two side assemblies toward each other. In order to meet the different needs of the users, the wheel chairs includes a first type that is designed for the users who can drive the wheels and move by their own, and a second type which is designed for the users who cannot operate the wheel chairs and have to be assisted by others. For the first type of the wheel chairs, the distance between the caster and the rear wheel is smaller than that of the second type so that the users of the first type wheel chairs can operate the wheels to move the wheel chairs. On the contrary, for the second type of the wheel chairs, the distance between the caster and the rear wheel has to be longer so as to be move in a stable status. Besides, the metal tubes are welded or soldered together and this takes a lot of time and is incurred by high cost.

### SUMMARY OF THE INVENTION

In accordance with one aspect of the present invention, there is provided a wheel chair assembly which comprises two identical side assemblies and a pivotable device is pivotally connected therebetween. Each side assembly includes a front part, a rear part, and atop link and a low link are respectively connected between the two first horizontal fittings and the two second horizontal fittings on the front part and the rear part. A hanger bracket with a footplate and a caster are respectively connected to the front part.

The rear part has a plurality of holes defined therein and two rear wheels each have a shaft which is inserted in one of the holes in each of the rear parts.

The primary object of the present invention is to provide a wheel chair that is assembled by modular side assemblies and the tubes of each of the side assemblies are positioned by screws.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the wheel chair of the present invention;

FIG. 2 is a side view to show the wheel chair of the present invention;

FIG. 3 is an exploded view to show one of the two side assemblies of the wheel chair of the present invention, and

FIG. 4 shows that the positions of the rear wheels can be adjusted.

### DETAILED DESCRIPTION OF THE PREFERRED EMBODIMENT

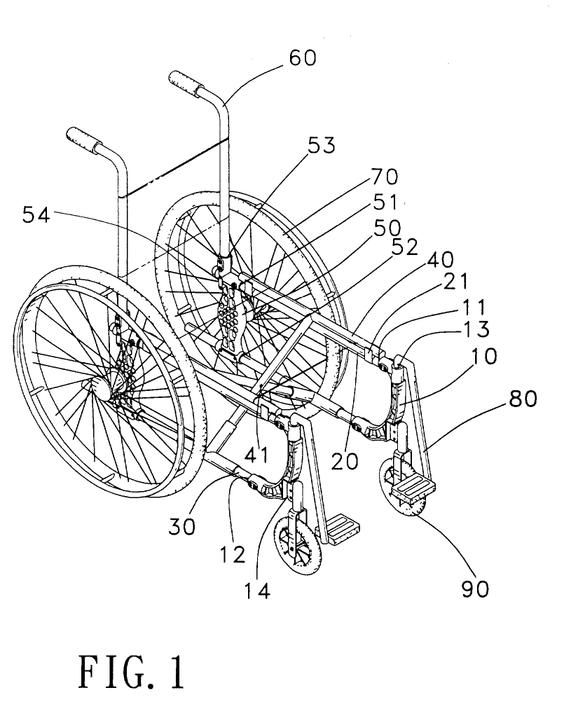

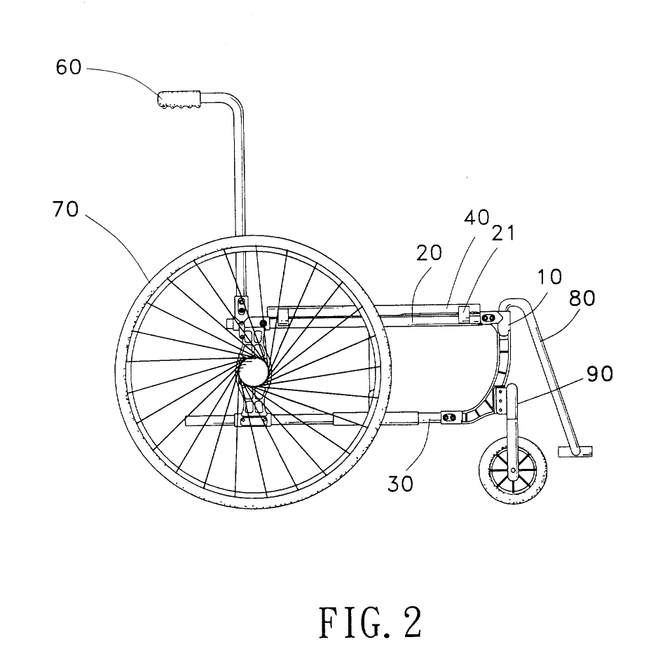

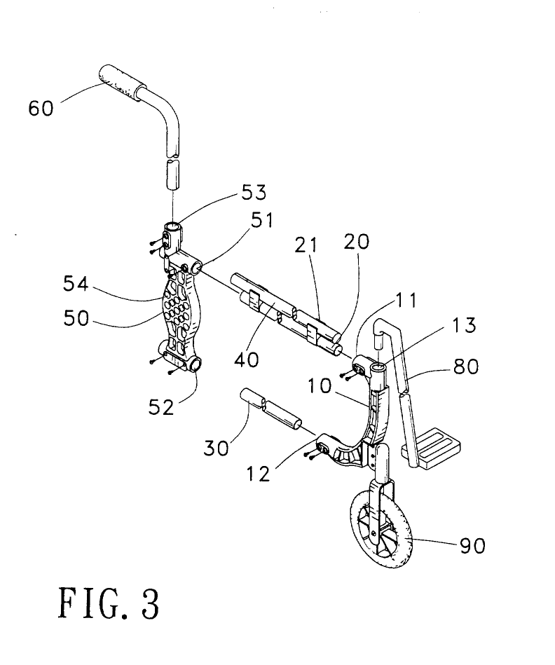

Referring to FIGS. 1 to 3, the wheel chair of the present invention comprises two identical side assemblies and each have a front part 10, a rear part 50, a top link 20 and a low link 30. The front part 10 has two first horizontal fittings 11, 12 extending from a rear side thereof for the top link 20 and the low link 30 inserted therein respectively. The top link 20 and the low link 30 are secured by extending screws through the two first horizontal fittings 11, 12. The top link 20 has two retaining members 21 extending therefrom for retaining a rod of the pivotable device which will be described later. A hanger bracket 80 has an insertion secured in a top hole 13 in the front part 10 and a footplate is connected to a lower end of the hanger bracket 80. A caster 90 has a connection plate 14 which is connected to the front part 10.

The rear part 50 has two second horizontal fittings 51, 52 for the other ends of the top link 20 and the low link 30 respectively inserted therein. The top link 20 and the low link 30 are also secured by extending screws through the two second horizontal fittings 51, 52. A handle 60 is connected to a top hole of the rear part 50 and a plurality of holes 54 are defined in the rear part 50. Two rear wheels 70 each have a shaft which is inserted in one of the holes 54 in each of the rear parts 50.

The pivotable device pivotably connected between the two side assemblies includes two H-shaped frames which are pivotably connected with each other at two respective intermediate points 41 thereof. Each of the two H-shaped frames has a tube at a first end thereof and the low link 30 passes through the tube. A rod 40 is connected to a second end of each of the two H-shaped frames and is engaged with the retaining member 21.

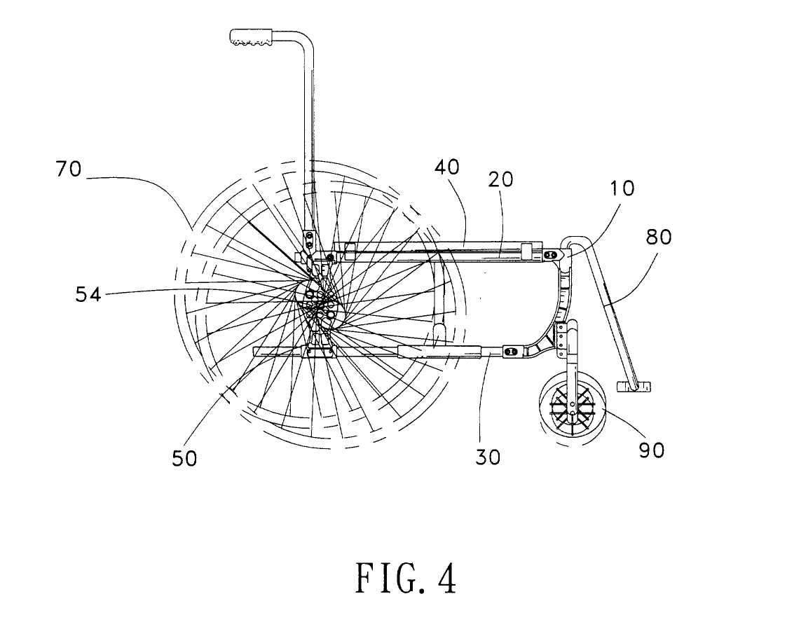

Referring to FIG. 4, the position of the rear wheels 70 can be adjusted by removing the shaft of the rear wheel 70 from one hole 54 to another so that the distance between the caster 90 and the rear wheel 70 can be adjusted. The way that the top links 20 and the low links 30 connected to the front part 10 and the rear part 50 are made by inserting the top links 20 and the low links 30 in the horizontal fittings 11, 12, 51 and 52 so that it is easily to be assembled and needs no soldering machines.

While we have shown and described the embodiment in accordance with the present invention, it should be clear to those skilled in the art that further embodiments may be made without departing from the scope of the present invention.

What is claimed is:

1. A wheel chair assembly comprising:
two identical side assemblies and each having a front part, a rear part, a top link and a low link, the front part having two first horizontal fittings for the top link and the low link inserted therein respectively, a hanger bracket connected to a top of the front part and a footplate connected to a lower end of the hanger bracket, a caster connected to the front part;
the rear part having two second horizontal fittings for two the other ends of the top link and the low link respectively inserted therein, a handle connected to a top of the rear part, a plurality of holes defined in the rear part;
a pivotable device pivotably connected between the two side assemblies, and
two rear wheels each having a shaft which is inserted in one of the holes in each of the rear parts.

2. The wheel chair assembly as claimed in claim 1, wherein the pivotable device includes two H-shaped frames which are pivotably connected with each other at two respective intermediate points thereof.

3. The wheel chair assembly as claimed in claim 2, wherein each of the two H-shaped frames has a tube at a first end thereof and the low link passes through the tube, a rod connected to a second end of each of the two H-shaped frames and each of the two top links has two retaining members which are engaged with the two respective rods of the two H-shaped frames.

4. The wheel chair assembly as claimed in claim 1 further comprising screws extending through each of the first horizontal fittings and the second horizontal fittings to fix the top links and the low links in the first horizontal fittings and the second horizontal fittings.
